(19) United States
(12) Patent Application Publication
(10) Pub. No.: US 2025/0316056 A1
(43) Pub. Date: Oct. 9, 2025

(54) METHOD AND SYSTEM FOR THE CRITERIA-BASED EXTRACTION OF IMAGE DATA

(71) Applicant: dSPACE GmbH, Paderborn (DE)

(72) Inventor: Daniel HASENKLEVER, Paderborn (DE)

(73) Assignee: dSPACE GmbH, Paderborn (DE)

(21) Appl. No.: 19/241,793

(22) Filed: Jun. 18, 2025

Related U.S. Application Data
(63) Continuation of application No. PCT/EP2023/086113, filed on Dec. 15, 2023.

(30) Foreign Application Priority Data
Dec. 19, 2022 (DE) 10 2022 133 819.3

(51) Int. Cl. G06V 10/75; G06V 10/764; G06V 10/94

(52) U.S. Cl. CPC G06V 10/75; G06V 10/764; G06V 10/95

(57) ABSTRACT

A computer-implemented method for the criteria-based extraction of image data, in particular individual images, from a data stream of image data recorded by a camera sensor of a motor vehicle. An aggregation of the characteristic vectors of the particular individual image forms a first individual image vector. A comparison is made of the first individual image vector with plurality of second individual image vectors stored in a data memory. A storage of the first individual image vector and/or the individual image belonging to the first individual image vector is made in the data memory depending on a fulfillment of at least one predefined comparison criterion. A system for the criterion-based extraction of image data is also provided.

This nonprovisional application is a continuation of International Application No. PCT/EP2023/086113, which was filed on Dec. 15, 2023, and which claims priority to German Patent Application No. 10 2022 133 819.3, which was filed in Germany on Dec. 19, 2022, and which are both herein incorporated by reference.

### FIELD OF THE INVENTION

The present invention relates to a computer-implemented method for the criteria-based extraction of image data, in particular individual images, from a data stream of image data recorded by a camera sensor of a motor vehicle. The present invention also relates to a system for the criteria-based extraction of image data, in particular individual images, from a data stream of image data recorded by a camera sensor of a motor vehicle. The invention further relates to a computer program, including program code, for the purpose of carrying out the method according to the invention. The invention additionally relates to a computer-readable data carrier, including program code of a computer program, for the purpose of carrying out the method according to the invention when the computer program is executed on a computer.

### DESCRIPTION OF THE BACKGROUND ART

Tianyang Wang, Jun Huan, Bo Li: “Data Dropout: Optimizing Training Data for Convolutional Neural Networks,” 2018, in IEEE 30th International Conference on Tools with Artificial Intelligence, discloses that the training of artificial neural networks may be improved by the targeted reduction of the training data.

The method comprises a receipt of a first item of input data from the first set of training data, a propagation of the first item of input data by the encoder, one or more characteristic vectors being assigned to the item of input data by the encoder, and a certain quantity of prototype characteristic vectors being ascertained depending on the assigned characteristic vectors and assigned to the first item of input data, a generation of an aggregated vector for the first item of input data, a carrying out of the aforementioned steps using a second item of input data from the first set of training data and generating a second aggregated vector for the second item of input data, a comparison of at least the first and the second aggregated vector and determination of a similarity measure of the aggregated vectors, and a marking or removal of the first item of input data from the first set of training data if the determined similarity measure exceeds a threshold value, the marking or removal resulting in the fact that the first item of input data from the first training data set is not used for a first training.

However, the aforementioned method has the disadvantage that specific input data are needed for the comparison of the aggregated vectors.

### SUMMARY OF THE INVENTION

It is therefore an object of the invention to specify a method for extracting image data from a data stream, which facilitates a more efficient data extraction according to defined requirements.

The object is achieved according to the invention by a computer-implemented method for the criteria-based extraction of image data, in particular individual images, from a data stream of image data recorded by a camera sensor of a motor vehicle. The object is also achieved according by a computer program as well as a computer-readable data carrier. The object is furthermore achieved according to the invention by a system for the criteria-based extraction of image data, in particular individual images, from a data stream of image data recorded by a camera sensor of a motor vehicle.

The invention relates to a computer-implemented method for the criteria-based extraction of image data, in particular individual images, from a data stream of image data recorded by a camera sensor of a motor vehicle.

The method comprises a provision of a data stream of image data recorded by the camera sensor of the motor vehicle as well as a generation of a characteristic vector for each object contained in an individual image of the data stream by means of a machine learning algorithm.

The method also comprises an aggregation of the characteristic vectors of the particular individual image to form a first individual image vector and a comparison of the first individual image vector with a plurality of second individual image vectors stored in a data memory.

The method further comprises a storage of the first individual image vector and/or the individual image belonging to the first individual image vector in the data memory depending on a fulfillment of at least one predefined comparison criterion.

The invention additionally relates to a computer program, including program code, for the purpose of carrying out the method according to the invention when the computer program is executed on a computer.

The invention furthermore relates to a computer-readable data carrier, including program code of a computer program, for the purpose of carrying out the method according to the invention when the computer program is executed on a computer.

The invention moreover relates to a system for the criteria-based extraction of image data, in particular individual images, from a data stream of image data recorded by a camera sensor of a motor vehicle.

The system comprises at least one camera sensor of the motor vehicle, which is configured to provide a data stream of image data.

The system also comprises a computing device inside the vehicle, which is configured to generate a characteristic vector for each object contained in an individual image of the data stream, using a machine learning algorithm, the computing device inside the vehicle being further configured to aggregate the characteristic vectors of the particular individual image to form a first individual image vector.

The system furthermore comprises a comparison device, which is configured to compare the first individual image vector with a plurality of second individual image vectors stored in a data memory.

The system moreover comprises a data memory, which is configured to store the first individual image vector and/or the individual image belonging to the first individual image vector depending on a fulfillment of at least one predefined comparison criterion.

Machine learning algorithms are based on the fact that statistical methods are used to train a data processing system in such a way that it may carry out a certain task without the latter having to be originally explicitly programmed for this purpose. The goal of machine learning is to construct algorithms which may learn from data and make predictions. These algorithms create mathematical models, with the aid of which, for example, data may be classified, in the present case objects being able to be detected.

Image data can be understood to be data which may be reproduced as an image or graphic with the aid of a special program. The fact that an object is represented in image data also means that the corresponding image data show the object; for example, they include a representation of the object.

An example of the present invention provides that a data recording is triggered, for example when a certain number and/or class of objects is/are present, and these objects are not yet present in sufficient quantity in the data memory. Characteristic vectors are stored in the data memory, which were recorded during travel. The data memory is designed to be live.

Characteristic vectors can also be stored in the data memory which come from previous recordings. With this approach, diverse items of data may be recorded, i.e., diverse within one recording drive as well as diverse with regard to an existing data pool. The data memory may thus also be used, for example, to record similar items of data, i.e., a conditional or criteria-based recording of data, for example to find similar test scenarios for the purpose of targeted testing.

Information from the current frame or individual image can be used together with information from individual images of the entire drive. The data memory may now be used to make comparisons according to similar content in a targeted manner and thus ensure diverse items of test and training data.

A number of objects comprised by the first individual image vector and represented by a particular characteristic vector can be compared with a number of objects comprised by the second individual image vector and represented by a particular characteristic vector, the first individual image vector and/or the individual image belonging to the first individual image vector being stored in the data memory if the number of the objects comprised by the first individual image vector and represented by the particular characteristic vector differs from the number of objects comprised by the second individual image vector and represented by the particular characteristic vector.

Characteristic vectors or objects represented by the corresponding characteristic vectors which are not currently contained in the data memory may thus be added to the data memory in a targeted manner. A diverse data set may thus be generated.

The characteristic vectors comprised by the first individual image vector can belong to a plurality of object classes, the first individual image vector and/or the individual image belonging to the first individual image vector being stored in the data memory if a number of characteristic vectors comprised by an object class of the first individual image vector is greater than a number of characteristic vectors comprised by an object class of the second individual image vector corresponding to the object class of the first individual image vector and/or a predefined first threshold value.

Characteristic vectors or objects represented by the corresponding characteristic vectors which belong to a predefined object class and which are not currently contained in sufficient quantity in the data memory may thus be added to the data memory in a targeted manner. An object class-diverse data set may thus be generated.

A comparison of the characteristic vectors comprised by the first individual image vector with the characteristic vectors comprised by the second individual image vector can be carried out, the first individual image vector and/or the individual image belonging to the first individual image vector being stored in the data memory if the characteristic vectors comprised by the first individual image vector, in particular in total or individually, have a deviation from the characteristic vectors comprised by the second individual image vector which is greater than or equal to a predefined second threshold value.

Characteristic vectors or objects represented by corresponding characteristic vectors which have a significant deviation from characteristic vectors already contained in the data memory may thus be added to the data memory.

The first individual image vector can be stored in a buffer prior to the comparison with the plurality of second individual image vectors stored in the data memory. An efficient extraction of individual images from the continuous data stream may take place hereby by means of comparison with the individual image vectors already stored in the data memory.

For example, an automatic extraction of pieces of information from the generated characteristic vectors, individual image vectors, and/or the assigned image data may also be additionally carried out to draw up an object list therefrom. The object list may include text-based pieces of information about the particular object, for example an object class, a dimension, color, and/or a designation of the object.

The first individual image vector can comprise coordinates of the objects represented by the characteristic vectors in the individual image and/or data relating to a direction of movement of the objects represented by the characteristic vectors in the individual image. The aforementioned pieces of information may thus be advantageously stored in the data memory in addition to the characteristic vectors.

The comparison of characteristic vectors comprised by the first individual image vector with the plurality of characteristic vectors stored in the data memory and comprised by the second individual image vectors can be carried out in real time during a test drive of the motor vehicle. This efficiently permits the extraction of individual images from the data stream in real time during a recording drive.

The data memory can be part of a vehicle-external server, in particular a cloud server, a real-time data communication between a vehicle-internal computing device and the vehicle-external server being carried out during the comparison of the characteristic vectors comprised by the first individual image vector with the plurality of characteristic vectors stored in the data memory and comprised by the second individual image vectors.

For example, this makes it possible for a plurality of test vehicles to communicate with the vehicle-external server in real-time communication independently of each other and/or at the same time and to add characteristic vectors defined according to predefined criteria to the data memory.

The generation of the characteristic vector can be carried out for each object contained in the individual image of the data stream by means of a machine learning algorithm, and the aggregation of the characteristic vectors of the particular individual image to form the first individual image vector is carried out on the vehicle-internal computing device.

A distribution of computing tasks may be advantageously carried out hereby, the particular individual image vectors of the data stream being compared with the individual image vectors present in each case in the data memory only after being generated by the vehicle-internal computing device.

The comparison of the characteristic vectors comprised by the first individual image vector with the plurality of characteristic vectors stored in the data memory and comprised by the second individual image vectors can be carried out, delayed in time after a test drive of the motor vehicle, using a vehicle-external computing device which communicates with the vehicle-external server.

Depending on the availability of the data link between the vehicle and the cloud server, a decision may thus be made as to which implementation is the most advantageous one. In the case of an unsatisfactory data link, it is thus advantageous to carry out the comparison of the first individual image vectors with the second individual image vectors shifted in time after the test drive, using the vehicle-external computing device, which communicates with the vehicle-external server.

The aggregation of the characteristic vectors of the particular individual image to form the first individual image vector can be carried out by concatenating the characteristic vectors. A corresponding individual image vector may thus be efficiently generated from the particular characteristic vectors.

The first individual image vector and/or the individual image belonging to the first individual image vector can be stored in the data memory to identify similar test cases if the characteristic vectors comprised by the first individual image vector have at least one predefined similarity measure with respect to the characteristic vectors comprised by the second individual image vector.

This makes it possible to ensure that correspondingly similar individual image vectors are stored in the data memory to thus generate data for carrying out similar test cases.

The features of the computer-implemented method described herein for the criteria-based extraction of image data, in particular individual images, from a data stream of image data recorded by a camera sensor of a motor vehicle may be also applied to the system for the criteria-based extraction of image data, in particular individual images, from a data stream of image data recorded by a camera sensor of a motor vehicle, and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a flowchart of a computer-implemented method for the criteria-based extraction of image data, in particular individual images, from a data stream of image data recorded by a camera sensor of a motor vehicle according to an example of the invention; and

FIG. 2 shows a schematic representation of a system for the criteria-based extraction of image data, in particular individual images, from a data stream of image data recorded by a camera sensor of a motor vehicle according to the example.

### DETAILED DESCRIPTION

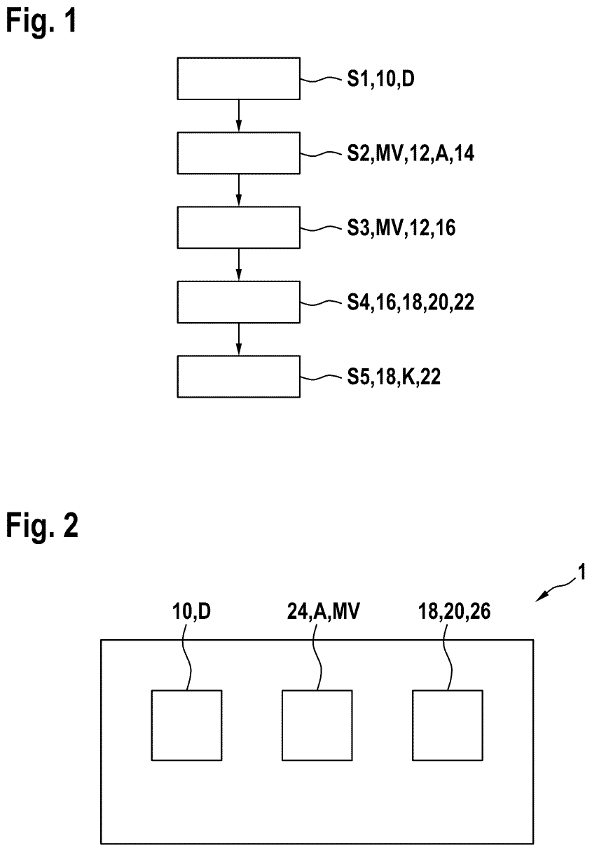

The computer-implemented method shown in FIG. 1 for the criteria-based extraction of image data D, in particular individual images, from a data stream of image data D recorded by a camera sensor 10 of a motor vehicle comprises a provision S1 of a data stream of image data D recorded by camera sensor 10 of the motor vehicle as well as a generation S2 of a characteristic vector MV for each object 14 contained in an individual image 12 of the data stream by means of a machine learning algorithm A.

The method also comprises an aggregation S3 of characteristic vectors MV of particular individual image 12 to form a first individual image vector 16 and a comparison S4 of first individual image vector 16 with a plurality of second individual image vectors 20 stored in a data memory 18.

The method further comprises a storage S5 of first individual image vector 16 and/or individual image 12 belonging to first individual image vector 16 in data memory 18 depending on a fulfillment of at least one predefined comparison criterion K.

A comparison S14a of a number of objects 14 comprised by first individual image vector 16 and represented by a particular characteristic vector MV with a number of objects 14 comprised by second individual image vector 20 and represented by a particular characteristic vector MV is furthermore carried out.

If the number of objects 14 comprised by first individual image vector 16 and represented by particular characteristic vector MV differs from the number of objects 14 comprised by second individual image vector 20 and represented by particular characteristic vector MV, first individual image vector 16 and/or individual image 12 belonging to first individual image vector 16 is/are stored in data memory 18.

Characteristic vectors MV comprised by first individual image vector 16 belong to a plurality of object classes. If a number of characteristic vectors MV comprised by an object class of first individual image vector 16 is greater than a number of characteristic vectors MV comprised by an object class of second individual image vector 20 corresponding to the object class of first individual image vector 16 and/or a predefined first threshold value, first individual image vector 16 and/or individual image 12 belonging to first individual image vector 16 is/are stored in data memory 18.

A comparison of characteristic vectors MV comprised by first individual image vector 16 with characteristic vectors MV comprised by second individual image vector 20 is additionally carried out. If characteristic image vectors MV comprised by first individual image vector 16, in particular in total or individually, have a deviation from characteristic vectors MV comprised by second individual image vector 20 which is greater than or equal to a predefined threshold value, first individual image vector 16 and/or individual image 12 belonging to first individual image vector 16 is/are stored in data memory 18.

First individual image vector 16 is also stored in a buffer prior to comparison S4 with the plurality of second individual image vectors 20 stored in data memory 18. First individual image vector 16 furthermore comprises coordinates of the objects represented by characteristic vectors MV in individual image 12 and/or data relating to a direction of movement of the objects represented by characteristic vectors MV in individual image 12.

The comparison of characteristic vectors MV comprised by first individual image vector 16 with the plurality of characteristic vectors MV stored in data memory 18 and comprised by second individual image vectors 20 is carried out in real time during a test drive of the motor vehicle.

Data memory 18 is part of a vehicle-external server 22, in particular a cloud server. During the comparison of characteristic vectors MV comprised by first individual image vector 16 with the plurality of characteristic vectors MV stored in data memory 18 and comprised by second individual image vectors 20, a real-time data communication is also carried out between a vehicle-internal computing device 24 and vehicle-external server 22.

Generation S2 of characteristic vector MV is carried out for each object 14 contained in individual image 12 of the data stream by means of a machine learning algorithm A, and aggregation S3 of characteristic vector MV of particular individual image 12 to form first individual image vector 16 is carried out on vehicle-internal computing device 24.

Alternatively, the comparison of characteristic vectors MV comprised by first individual image vector 16 with the plurality of characteristic vectors MV stored in data memory 18 and comprised by second individual image vectors 20 may be carried out, delayed in time after a test drive of the motor vehicle, using a vehicle-external computing device, which communicates with vehicle-external server 22.

Aggregation S3 of characteristic vectors MV of particular individual image 12 to form individual image vector 16 is also carried out by concatenating characteristic vectors MV. To identify similar test cases, first individual image vector 16 and/or individual image 12 belonging to first individual image vector 16 is/are stored in data memory 18 if characteristic vectors MV comprised by first individual image vector 16 have at least one predefined similarity measure with respect to characteristic vectors MV comprised by second individual image vector 20.

FIG. 2 shows a schematic representation of a system for the criteria-based extraction of image data D, in particular individual images, from a data stream of image data D recorded by a camera sensor 10 of a motor vehicle according to the example of the invention.

The system comprises at least one camera sensor 10 of the motor vehicle, which is configured to provide a data stream of image data D.

The system also comprises a vehicle-internal computing device 24, which is configured to generate a characteristic vector MV for each object 14 contained in an individual image 12 of the data stream, using a machine learning algorithm A, vehicle-internal computing device 24 being further configured to aggregate characteristic vectors MV of particular individual image 12 to form a first individual image vector 16.

The system furthermore comprises a comparison device 26, which is configured to compare first individual image vector 16 with a plurality of second individual image vectors 20 stored in a data memory 18.

The system additionally comprises data memory 18, which is configured to store first individual image vector 16 and/or individual image 12 belonging to first individual image vector 16 depending on a fulfillment of at least one predefined comparison criterion K.

Although examples have been illustrated and described herein, it is understandable to those skilled in the art that a multiplicity of alternative and/or equivalent implementations exist. It should be noted that the examples are only examples and are not used to limit the scope, the applicability, or the configuration in any way.

Rather, the aforementioned summary and detailed description provide those skilled in the art with a convenient set of instructions on the implementation of at least one example, it being understandable that different modifications in the range of functions and the arrangement of the elements may be carried out without deviating from the scope of the appended claims and their legal equivalents.

This application generally intends to cover changes and adaptations or variations in the examples illustrated herein. For example, a sequence of the method steps may be modified. The method may also be carried out sequentially or in parallel, at least in sections.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for the criteria-based extraction of image data or individual images from a data stream of image data recorded by a camera sensor of a motor vehicle, the method comprising:
providing a data stream of image data recorded by the camera sensor of the motor vehicle;
generating a characteristic vector for each object contained in an individual image of the data stream via a machine learning algorithm;
aggregating the characteristic vectors of the particular individual image to form a first individual image vector;
comparing the first individual image vector with a plurality of second individual image vectors stored in a data memory; and
storing the first individual image vector and/or the individual image belonging to the first individual image vector in the data memory depending on a fulfillment of at least one predefined comparison criterion.

2. The computer-implemented method according to claim 1, wherein a number of objects comprised by the first individual image vector and represented by a particular characteristic vector are compared with a number of objects comprised by the second individual image vector and represented by a particular characteristic vector, wherein the first individual image vector and/or the individual image belonging to the first individual image vector are stored in the data memory if the number of the objects comprised by the first individual image vector and represented by the particular characteristic vector differs from the number of objects comprised by the second individual image vector and represented by the particular characteristic vector.

3. The computer-implemented method according to claim 1, wherein the characteristic vectors comprised by the first individual image vector belong to a plurality of object classes, the first individual image vector and/or the individual image belonging to the first individual image vector is/are stored in the data memory if a number of characteristic vectors comprised by an object class of the first individual image vector is greater than a number of characteristic vectors comprised by an object class of the second individual image vector corresponding to the object class of the first individual image vector and/or a predefined first threshold value.

4. The computer-implemented method according to claim 1, wherein a comparison of the characteristic vectors comprised by the first individual image vector with the characteristic vectors comprised by the second individual image vector is carried out, wherein the first individual image vector and/or the individual image belonging to the first individual image vector are stored in the data memory if the characteristic vectors comprised by the first individual image vector, in total or individually, have a deviation from the characteristic vectors comprised by the second individual image vector, which is greater than or equal to a predefined second threshold value.

5. The computer-implemented method according to claim 1, wherein the first individual image vector is stored in a buffer prior to the comparison with the plurality of second individual image vectors stored in the data memory.

6. The computer-implemented method according to claim 1, wherein the first individual image vector comprises coordinates of the objects represented by the characteristic vectors in the individual image and/or data relating to a direction of movement of the objects represented by the characteristic vectors in the individual image.

7. The computer-implemented method according to claim 1, wherein the comparison of the characteristic vectors, comprised by the first individual image vector with the plurality of characteristic vectors stored in the data memory and comprised by the plurality of second individual image vectors, is carried out in real time during a test drive of the motor vehicle.

8. The computer-implemented method according to claim 1, wherein the data memory is part of a vehicle-external server or a cloud server, wherein a real-time data communication between a vehicle-internal computing device and the vehicle-external server is carried out during the comparison of the characteristic vectors comprised by the first individual image vector with the plurality of characteristic vectors stored in the data memory and comprised by the second individual image vectors.

9. The computer-implemented method according to claim 8, wherein the generation of the characteristic vector is carried out for each object contained in the individual image of the data stream via a machine learning algorithm, and wherein the aggregation of the characteristic vectors of the particular individual image to form the first individual image vector is carried out on a vehicle-internal computing device.

10. The computer-implemented method according to claim 1, wherein the comparison of the characteristic vectors comprised by the first individual image vector with the plurality of characteristic vectors stored in the data memory and comprised by the second individual image vectors is carried out, delayed in time after a test drive of the motor vehicle, using a vehicle-external computing device, which communicates with a vehicle-external server.

11. The computer-implemented method according to claim 1, wherein the aggregation of the characteristic vectors of the particular individual image to form the first individual image vector is carried out by concatenating the characteristic vectors.

12. The computer-implemented method according to claim 1, wherein, to identify similar test cases, the first individual image vector and/or the individual image belonging to the first individual image vector is/are stored in the data memory if the characteristic vectors comprised by the first individual image vector have at least one predefined similarity measure with respect to the characteristic vectors comprised by the second individual image vector.

13. A computer program, comprising program code, for carrying out the method according to claim 1 when the computer program is executed on a computer.

14. A computer-readable data carrier, comprising program code of a computer program, for carrying out the method according to claim 1 when the computer program is executed on a computer.

15. A system for criteria-based extraction of image data or individual images from a data stream of image data recorded by a camera sensor of a motor vehicle, the system comprising:
at least one camera sensor of the motor vehicle, which is configured to provide a data stream of image data;
a vehicle-internal computing device, which is configured to generate a characteristic vector for each object contained in an individual image of the data stream, using a machine learning algorithm, the vehicle-internal computing device being further configured to aggregate the characteristic vectors of the particular individual image to form a first individual image vector;
a comparator, which is configured to compare the first individual image vector with a plurality of second individual image vectors stored in a data memory, the data memory being configured to store the first individual image vector and/or the individual image belonging to the first individual image vector depending on a fulfillment of at least one predefined comparison criterion.
